(19) United States
(12) Patent Application Publication
(10) Pub. No.: US 2017/0158016 A1
(43) Pub. Date: Jun. 8, 2017

(54) AIR SUSPENSION INDVIDUAL CORNER CONTROL TO OPTIMIZE TRACTION

(71) Applicant: Continental Automotive Systems, Inc., Auburn Hills, MI (US)

(72) Inventors: Heidi K. Hahn, Swartz Creek, MI (US); Harald Schaumburg, Sarstedt (DE); Christof Behmenburg, Lauenau (DE); Kent R. Young, Auburn Hills, MI (US)

(73) Assignee: Continental Automotive Systems, Inc., Auburn Hills, MI (US)

(21) Appl. No.: 15/366,011

(22) Filed: Dec. 1, 2016

Related U.S. Application Data
(60) Provisional application No. 62/263,176, filed on Dec. 4, 2015.

(51) Int. Cl. B60G 17/016; B60G 17/015

(52) U.S. Cl. CPC B60G 17/0162; B60G 17/0155

(57) ABSTRACT

An air suspension system for a vehicle comprises four corner assemblies, wherein one corner assembly is located at a suspension position corresponding to each of the wheel corners for the vehicle. An air supply unit including a compressor, and an ECU are connected to the corner assemblies. The air supply unit is capable of independently adjusting the corner assemblies from one another. A sensor for measuring jounce/rebound travel for a wheel is associated with each of the corner assemblies and the air suspension system is operable adjust the air pressure at each of the four corner assemblies to provide optimized traction for the vehicle when at least one of the wheels has a predetermined amount of travel.

### CROSS REFERENCE TO RELATED APPLICATIONS

This U.S. patent application claims the benefit of provisional patent application 62/263,176, filed Dec. 4, 2015, which is hereby incorporated by reference

### TECHNICAL FIELD

The present disclosure relates to automotive vehicles and more particularly to adjustable suspension systems for automotive vehicles.

### BACKGROUND

Suspension systems for automotive vehicles provide vehicle passengers with a more comfortable ride. Demand from vehicle owners for more controls and options has led to the development of adjustable air suspension systems. Depending on the current driving surface, different suspension operating modes may be selected by the vehicle operator. The suspension operating modes have present suspension parameters to provide the ideal suspension arrangement for various driving situations. Typical operating modes a driver may select include, a standard driving mode, a snow mode, an off-roading mode, etc.

In addition to providing selected operating modes for various driving situations the suspension system may be adjusted when select operating conditions are met. For example, the vehicle height may be lowered when operating above a predetermined operating speed to obtain a better aerodynamic profile for the vehicle. Thus, adjustable air suspension systems provide a vehicle operator with a more efficient driving experience.

Sport utility vehicles (SUV) and trucks can be used off road for rock climbing and other surfaces that are uneven compared to normal driving roads. Many off road enthusiasts are interested in the ramp travel index (RTI) or axle articulations of the vehicle. Ramp travel index rating is used to test and describe chassis limits of vehicles. A high axle articulation is good for off road performance on severe routes. Most stock SUVs have RTI measure values from 400-550.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of adjusting an air suspension system for a vehicle comprises activating a traction optimization mode, and determining with an ECU an optimal pressure for each individual corner of the air suspension system to provide an optimal amount of traction for the vehicle. The ECU determines the manner to adjust each corner including to either increase or decrease pressure for each corner to achieve the optimal pressure at the corner based on a current pressure and controls the air supply in the determined manner to adjust the air spring pressures. The traction optimization mode is deactivated and the suspension system is adjusted to another mode by changing the air spring pressures.

An air suspension system for a vehicle comprises four corner assemblies, wherein one corner assembly is located at a suspension position corresponding to each of the wheel corners for the vehicle. An air supply unit including a compressor, and an ECU are connected to the corner assemblies. The air supply unit is capable of independently adjusting the corner assemblies from one another. A sensor for measuring jounce/rebound travel for a wheel is associated with each of the corner assemblies and the air suspension system is operable adjust the air pressure at each of the four corner assemblies to provide optimized traction for the vehicle when at least one of the wheels has a predetermined amount of travel.

Other objects, features and characteristics of the present invention, as well as the methods of operation and the functions of the related elements of the structure, the combination of parts and economics of manufacture will become more apparent upon consideration of the following detailed description and ap-pended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a vehicle having an air suspension system of the present invention;

FIG. 2 is a schematic illustration of a frame for the vehicle having the air suspension system of FIG. 1;

FIG. 3 is a schematic illustration of the vehicle having the air suspension system of FIGS. 1-2 illustrating example tire pressures for the vehicle tires;

FIG. 4 is a schematic illustration of the vehicle having the air suspension system of FIGS. 1-3 illustrating an example method of traction optimization.

### DETAILED DESCRIPTION

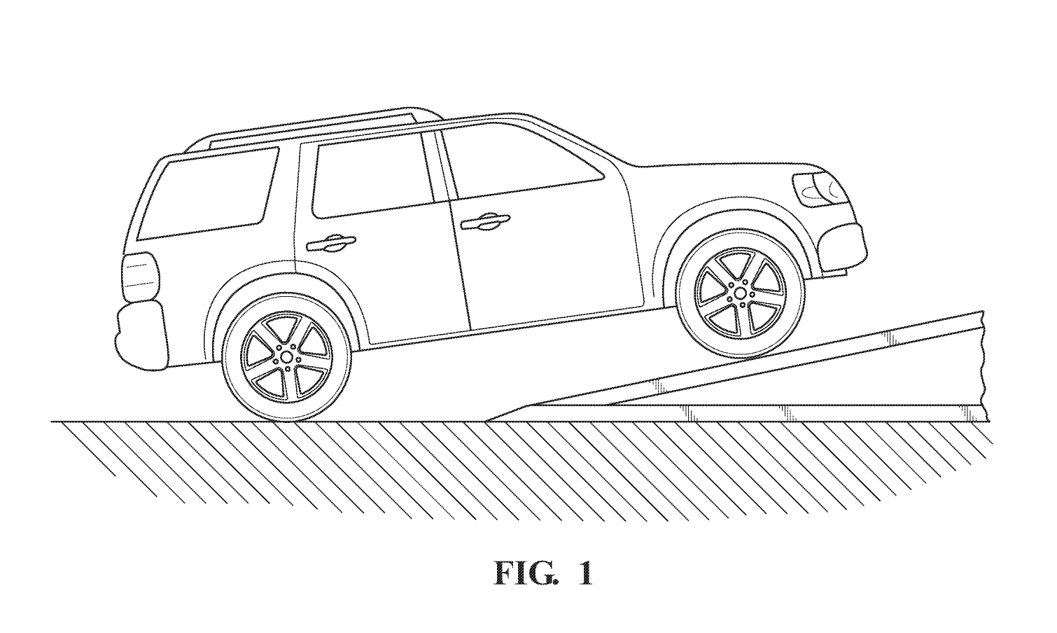

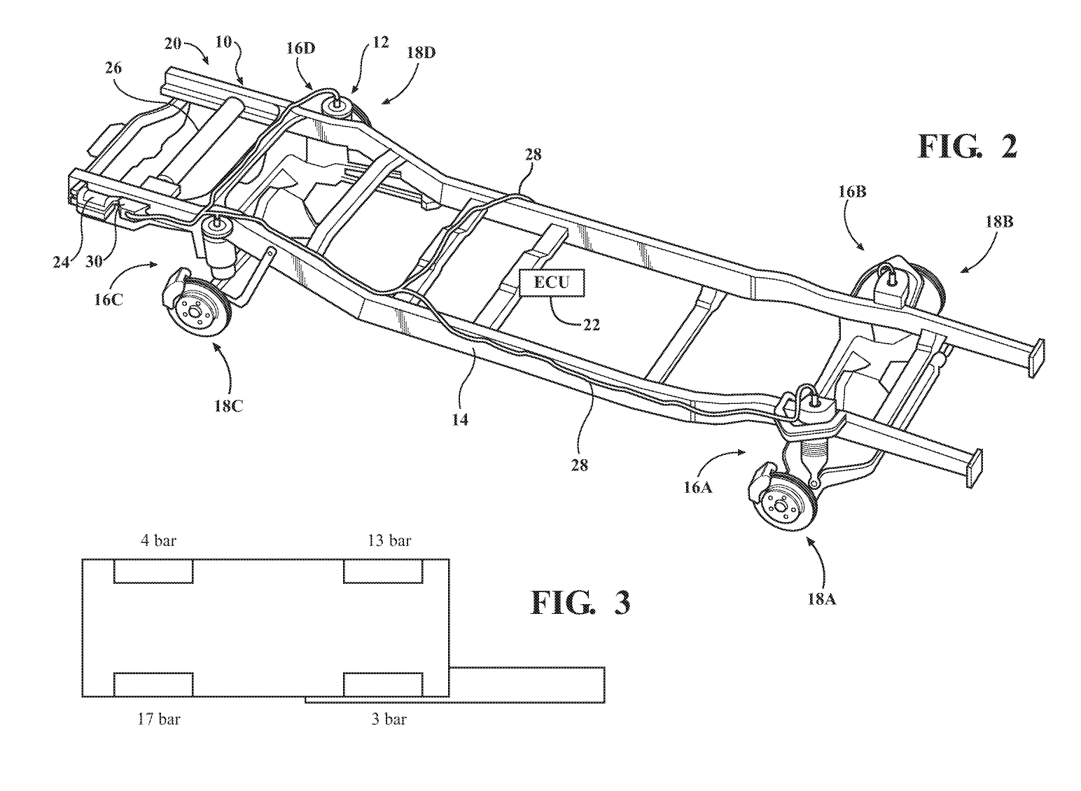

The following description is merely exemplary in nature and is in no way intended to limit the disclosure, its application, or uses. For purposes of clarity, the same reference numbers will be used in the drawings to identify similar elements. FIGS. 1 and 2 illustrate a vehicle, in this instance an SUV 10 having an air suspension system 12. The air suspension system 12 is supported by a frame 14. The air suspensions system has four corner assemblies 16A-D located at each of the wheel 18 locations of the vehicle 10. The four corner assemblies 16A-D may be independently adjustable. Two corner assemblies 16A, B are located at the front wheel 18A, B corners of the vehicle 10 and two corner assemblies 16C, D are located at the rear wheel 18C, D corners of the vehicle.

The air suspension system 12 includes an air supply unit 20 fluidly connected to the four corner assemblies 16A-D. The air supply unit 20 includes an electronic control unit 22, a compressor 24, a reservoir 26 and a valve block 30. The individual components of the air supply unit may be assembled together or supported on the vehicle at separate locations. In the embodiment shown the ECU 22 is located remote from the compressor 24, reservoir 26 and valve block 30. The individual components of the air supply unit 20 may be assembled together or supported on the vehicle 10 at separate locations. In the embodiment shown, the ECU 22 is located remote from the compressor 24, reservoir 26 and valve block 30 (electrical connections not shown). Alternatively, the air suspensions system 12 may be an open loop system and the air supply unit may not include a reservoir 26.

The air supply unit 20 is connected to the four corner assemblies 16A-D through the supply lines 28. In the example shown, the air suspension system 12 is a closed system. The valve block 30 is controlled by the ECU 22 to regulate the air supply between the compressor 24, the reservoir 26 and the four corner assemblies 16A-D. The valve block 30 may be a single unit defining multiple valves, multiple valves located together, or multiple valves at different locations. Additionally, the reservoir 26 may be a single or multiple tank assembly.

The four corner assemblies 16A-D are adjustable to accommodate various driving conditions. Based upon the selected suspension mode the ECU 22 will regulate the air supply between the compressor 24, reservoir 26 and the four corner assemblies 16A-D to adjust the four corner assemblies 16A-D from the current positions to the desired positions. When lowering any of the corner assemblies 16A-D the excess air is sent to the reservoir 26 for storage. When raising any of the corner assemblies 16A-D the required air is sent from the reservoir 26 to the appropriate corner assembly 16A-D. The compressor 24 ensures that the air pressure within the system 12 is maintained at the desired level. Alternately, in the instance of an open system the excess air is released to the environment or pulled from the environment and pressurized as needed. The compressor 24 ensures that the air pressure within the system 12 is maintained at the desired level.

The air suspension system 12 is adjusted at the direction of the vehicle operator by moving a selector, or when pre-determined operating conditions exist, e.g. the vehicle 10 accelerates above a certain speed and the suspension system 12 is lowered, when the vehicle 10 decelerates below a predetermined threshold the suspension system 12 raised. Therefore, the air suspension system 12 may be adjusted while the vehicle 10 is in motion. In this instance, the front corner assemblies 16A, B may be adjustable together and the rear corner assemblies 16C, D may be adjustable together. To provide the most aerodynamic adjustment possible, when the vehicle is travelling in a forward direction, the rear corner assemblies are adjusted to the new position first when the suspension system 12 is raised. However, when the suspension system 12 is lowered, the front corner assemblies 16A, B are adjusted to the new position first. Alternately, each corner 16A-D could be adjusted separately or all corners 116A-D could be adjusted simultaneously.

FIGS. 1-3 are schematic illustrations of a vehicle 10 with the air suspension system 12. FIG. 1 illustrates the vehicle where one wheel is elevated compare to the others. The air springs 16A-D can be individually controlled to maintain as much contact with a tractive surface as possible. By sensing both the wheel travel and wheel load, the algorithm can adjust the pressure at each corner to optimize traction. The pressure at each corner can be either raised or lowered. Raising the pressure will move the vehicle downward in the rebound direction and lowering the pressure will move the wheel upward in the jounce direction.

This mode could be enabled by the driver, or alternatively, could be activated automatically when certain pre-set conditions are met. However, this mode can only be activated when the vehicle is either stopped or moving very slowly, e.g. less than 3-5 mph. Adjusting, the air suspension pressure at the individual corners can be used in off road performance situations where there are large variations in the driving surface, to improve the Ramp Test Index (RTI) performance of a vehicle, and for improving traction for a vehicle that is stuck on uneven surfaces, e.g. a snow bank.

FIG. 3 illustrates one example where the air suspension 12 of the current invention is used. The different pressures for the associated air spring are shown for situations where an individual corner is elevated compared to the other corners. The air spring pressure for the elevated wheel is deflated, as well as for the air spring at the diagonally opposing corner. The remaining two wheels, forming the opposing diagonal of the first two will have elevated air spring pressures, to help increase the clearance.

Another example is shown in FIG. 1 where RTI for a vehicle is calculated, one forward wheel is placed on a ramp, which is at a 15-30 degree angle. The vehicle is moved forward until one of the other three tries begins to leave the ground. The vehicle is then back down until all 3 tires are still o the ground. The distance travelled up the ramp is then measured and divided by the vehicle's wheelbase and multiplied by 1000 to give an RTI score, where b is the wheelbase for the vehicle, d is the distance travelled along the ramp, and r is the calculated RTI:

$$r = \frac{d}{b} \times 1 , 000$$

When the pressure in the air spring is controlled, as described in relation to FIG. 3, decreasing air spring pressure of the corner where wheel on the ramp and the diagonally opposite and increasing air spring pressure of the opposing diagonal corners the RTI rate increases as well, for example a 25% increase.

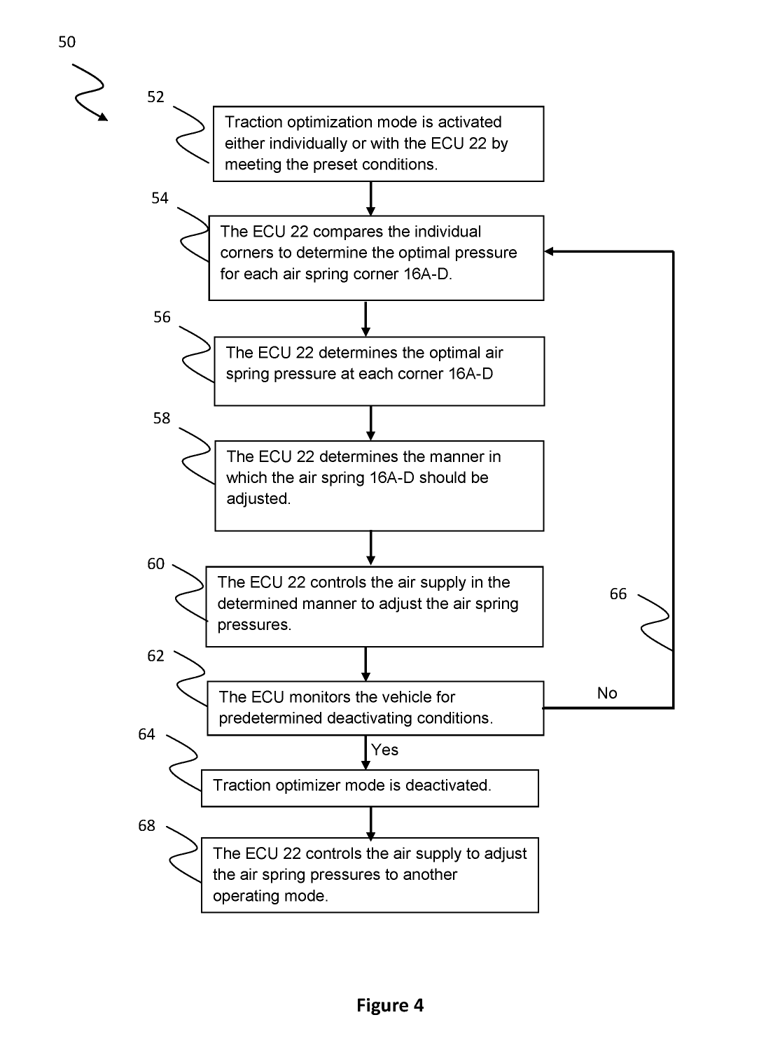

Referring to FIGS. 1-4 one embodiment of a method of adjusting an air suspension system is described, shown at 50. The traction optimization mode is activated either individually or by meeting the preset conditions, shown at 52. The ECU 22 compares the individual corners to determine the optimal pressure for each air spring corner 16A-D, shown at 54. The ECU 22 may receive data from the vehicle sensors (not shown) to detect these and other conditions including, but not limited to: wheel travel (jounce or rebound) at each corner, vehicle load at each corner, vehicle speed, etc. Based on this information the ECU 22 determines the optimal air spring pressure at each corner 16A-D, shown at 56. For each air spring 16A-D the ECU 22 also determines the manner in which the air spring 16A-D should be adjusted including if the pressure needs to be increased or decreased from the current pressure and the order in which the air spring corners 16A-D should be adjusted, shown at 58. For example, those needing an increase in pressure may be adjusted first, starting with the largest increase or simultaneously increased to the optional pressure. Then ECU 22 controls the air supply in the determined manner to adjust the air spring pressures, shown at 60. The ECU 62 monitors the vehicle for predetermined conditions which will automatically cause the traction optimizer mode to end, shown as 62. One way for the traction optimizer mode to terminate is if the vehicle 10 were to start travelling above a preset speed or if other present conditions were no longer met The traction optimizer mode can then be deactivated manually or automatically. The traction optimizer mode can then be deactivated manually or automatically. Whether automatic or manually the traction optimizer mode is deactivated, shown at 64 or can continue to operate and adjust air spring pressures using the traction optimization mode, shown at 66.

When the traction optimizer mode is ended the ECU 22 adjusts the suspension system to another mode by changing the air spring pressures accordingly, shown at 68. The ending mode may be to the previous automatically selected mode, a new manually selected more, or a new automatically selected mode.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A method of adjusting an air suspension system for a vehicle comprising:
activating a traction optimization mode;
determining with an ECU an optimal pressure for each individual corner of the air suspension system to provide an optimal amount of traction for the vehicle;
determining with the ECU the manner to adjust each corner including to either increase or decrease pressure for each corner to achieve the optimal pressure at the corner based on a current pressure;
controlling the air supply with the ECU in the determined manner to adjust the air spring pressures;
deactivating the traction optimization mode; and
adjusting the suspension system to another mode by changing the air spring pressures.

2. The method of claim 1, wherein activating the traction optimization mode occurs one of manually and automatically by meeting the preset conditions.

3. The method of claim 1, determining with the ECU the manner to adjust each corner further comprises receiving data from the vehicle sensors to detect at least one of: wheel jounce at each corner, wheel rebound at each corner, vehicle load at each corner, vehicle speed.

4. The method of claim 1, determining with the ECU the manner to adjust each corner further comprises determining an order in which the air spring corners should be adjusted.

5. The method of claim 1, further comprising:
determining a vehicle speed;
comparing the vehicle speed to a predetermined speed threshold; and
wherein the ECU deactivates the traction optimization mode when the vehicle speed is above the predetermined threshold.

6. An air suspension system for a vehicle comprising:
four corner assemblies, wherein one corner assembly is located at a suspension position corresponding to each of the wheel corners for the vehicle;
an air supply unit including a compressor, and an ECU connected to the corner assemblies, wherein the air supply unit is capable of independently adjusting the corner assemblies from one another;
a sensor for measuring jounce/rebound travel for a wheel associated with each of the corner assemblies; and
wherein the air suspension system is operable adjust the air pressure at each of the four corner assemblies to provide optimized traction for the vehicle when at least one of the wheels has a predetermined amount of travel.

7. The air suspension system of claim 6, wherein the air suspensions system will adjust for optimal traction only when the vehicle is below a preselected speed.
